(19) United States
(12) Patent Application Publication
(10) Pub. No.: US 2010/0208134 A1
(43) Pub. Date: Aug. 19, 2010

(54) Digital Television System and Receiver and Associated Method for Providing Information of Point of Interest

(75) Inventors: Meng-Shu Lee, Hsinchu Hsien (TW); Yung-Chi Fan, Hsinchu Hsien (TW)

Correspondence Address: WPAT, PC;INTELLECTUAL PROPERTY ATTORNEYS, 7225 BEVERLY ST., ANNANDALE, VA, 22003, US

(73) Assignee: MStar Semiconductor, Inc., Hsinchu Hsien (TW)

(21) Appl. No.: 12/487,870

(22) Filed: Jun. 19, 2009

(30) Foreign Application Priority Data
Feb. 17, 2009 (TW) 098104898

(51) Int. Cl. H04N 7/00; H04N 5/44

(52) U.S. Cl. 348/461; 348/725; 348/E05.096; 348/E07.001

(57) ABSTRACT

The present invention provides a digital television (TV) system and receiver which are capable of providing information of point of interest (POI) associated with programs or advertisements. A transmitting end of the digital TV system adds information of a POI included in a digital AV data into the digital AV data, so as to generate a digital AV signal to be transmitted. A receiving end of the digital TV system includes a digital AV receiver and a display device. The digital AV receiver receives and decodes the digital AV signal to generate the information of the POI. The display device displays the information of the POI.

### CROSS REFERENCE TO RELATED PATENT APPLICATION

This patent application is based on a Taiwan, R.O.C. patent application No. 98104898 filed on Feb. 17, 2009.

### FIELD OF THE INVENTION

The present invention relates to a digital television (TV) system, and more particularly, to a digital TV receiver and system and associated method for providing information of points of interest (POIs).

### BACKGROUND OF THE INVENTION

At present, Digital Video Broadcasting (DVB) is one of the main transmission standards applied to the digital TV system. As the DVB standard is widely used in mobile digital TV devices, a user is able to watch a digital TV conveniently while walking or riding on a vehicle.

However, when watching a certain program or advertisement of the digital TV, the user can not conveniently or immediately obtain further information associated with POIs, such as stores, restaurants, scenic areas, and so on, shown in the program or advertisement. For example, the information of a POI can include a phone number, an address, a longitudinal and latitudinal position, and service hours of the POI. The user himself has to search the Internet or call a TV station to obtain such information. Especially, when the user is using the mobile digital TV while traveling outdoors, it is not convenient to search the Internet to obtain the information of the POIs. In other words, the current digital TV service including the mobile digital TV service does not provide detailed information of POIs associated with a program or advertisement, which causes inconvenience for the user.

### SUMMARY OF THE INVENTION

In view of the foregoing issues, one object of the present invention is to provide a digital TV receiver and system and associated method for providing information of a POI. Therefore, information of the POI associated with a program or advertisement is provided to a user conveniently and immediately.

According to the present invention, a digital TV system comprises a transmitting end and a receiving end. The transmitting end adds information of a POI relating to a digital audio-video (AV) data into the digital AV data, encodes the digital AV data as a digital AV signal, and transmits the digital AV signal. The receiving end comprises a digital AV receiver and a display device. The digital AV receiver receives and decodes the digital AV signal to obtain the information of the POI. The display device coupled to the digital AV receiver displays the information of the POI.

According to another aspect of the present invention, a digital TV system comprises a decoder and a search engine. The decoder decodes a digital AV signal to generate a digital AV data. The search engine recognizes a POI from the digital AV data, and searches the POI in a POI database to output the information of the POI.

Moreover, according to the present invention, a method for providing information of a POI is applied to a receiving end of a digital TV system. The transmitting end of the digital TV system adds information of the POI related with a digital AV data into the digital AV data, and encodes digital AV data to generate a digital AV signal. The method comprises steps of receiving the digital AV signal, decoding the digital AV signal to obtain the information of the POI, and displaying the information of the POI.

Furthermore, according to another aspect of the present invention, a method for providing information of a POI is applied to a digital AV receiver. The method comprises steps of receiving and decoding a digital AV signal to generate a digital AV data, recognizing the POI from the digital AV data, and searching a POI database according to the POI to obtain the information of the POI.

### BRIEF DESCRIPTION OF THE DRAWINGS

FIG. 1A is a block diagram of a DVB system in accordance with an embodiment of the present invention.

FIG. 1B shows a format of a PES packet.

FIG. 1C is a block diagram of a DVB receiver shown in FIG. 1A in accordance with a preferred embodiment of the present invention.

FIG. 2 is a block diagram of a DVB receiver in accordance with an embodiment of the present invention.

FIG. 3 is a flow chart of a method for providing information of a POI in accordance with an embodiment of the present invention.

FIG. 4 is a flow chart of a method for providing information of a POI in accordance with another embodiment of the present invention.

### DETAILED DESCRIPTION OF THE PREFERRED EMBODIMENT

Common digital TV systems comprise the DVB system, the Advance Television Systems Committee (ATSC) system specified by the ATSC, the Integrated Services Digital Broadcasting (ISDB) system, and the Digital Multimedia Broadcast (DMB) system. The digital TV systems are generally classified into wired systems and wireless systems. The system and method thereof, provided according to the present invention, for providing information of POIs of TV programs or advertisements, can be applied to the foregoing digital TV systems. The following description takes the DVB system as an example to describe the system and method thereof of the present invention; however, it shall not be construed as limiting the scope of inventive concepts disclosed and/or claimed herein.

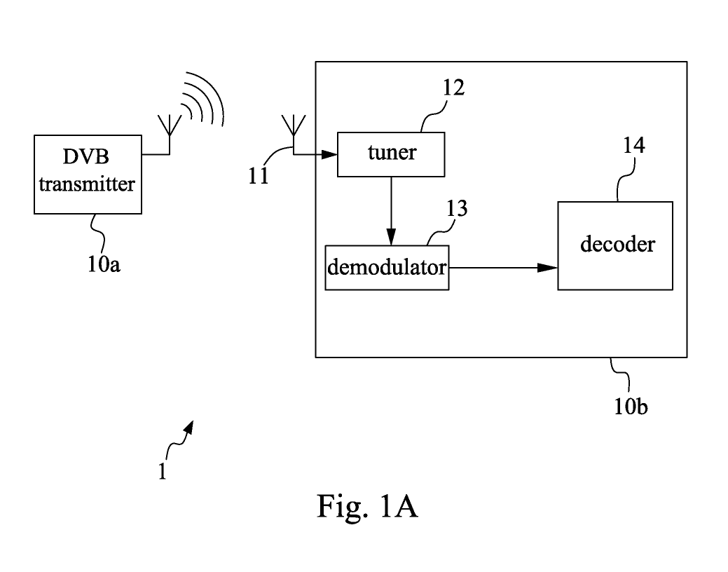

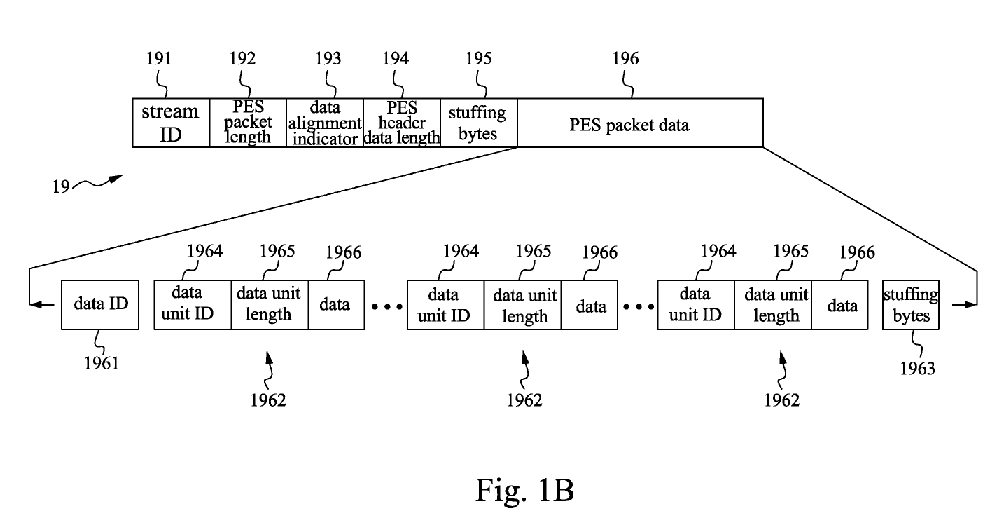

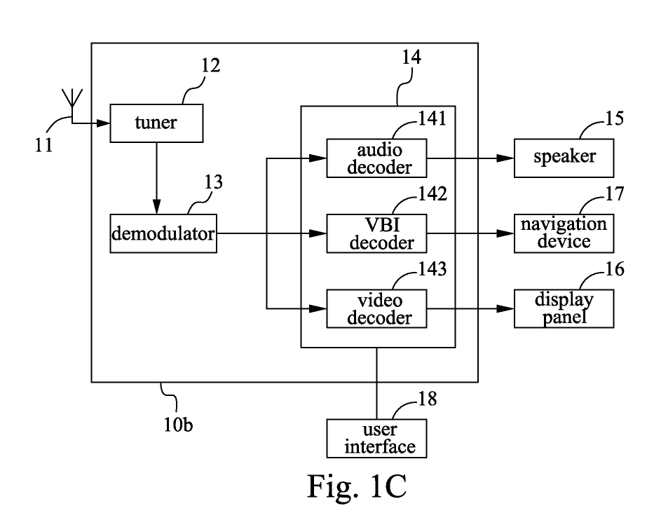

FIG. 1A is a block diagram of a DVB system in accordance with an embodiment of the present invention. A DVB system 1 comprises a DVB transmitter 10a, and a DVB receiver 10b. The DVB receiver 10b comprises an antenna 11, a tuner 12, a demodulator 13 and a decoder 14. In this embodiment, a DVB service provider such as a TV station or a mobile communication service provider adds information of a POI which is relating to a DVB audio-video (AV) data such as a program or an advertisement into the DVB AV data in advance at a transmitting end. For example, the information of the POI may include a name, a phone number, a longitudinal and latitudinal position, an address, service hours, a menu, and a sales promotion message of the POI, and so on. The DVB AV data is encoded to generate a DVB signal, which is then modulated and converted to a radio frequency (RF) signal to be transmitted via the DVB transmitter 10a. The DVB receiver 10b at a receiving end receives the DVB RF signal via the antenna 11. The tuner 12 converts the DVB RF signal into an intermediate frequency (IF) signal and then transmits the IF signal to the demodulator 13. The demodulator 13 converts the analog IF signal to a digital stream signal which is the original DVB signal. The decoder 14 decodes the DVB signal to generate the DVB AV data and the information of the POI added at the transmitting end. The information of the POI decoded by the decoder 14 can be directly provided to a user for reference. For example, the information of the POI can be displayed on a display device (not shown) coupled to the decoder 14. Moreover, the information of the POI can be transmitted to other hardware devices or application software that is capable of providing location based service, such as an electronic device (not shown) having a navigation function. Accordingly, the electronic device can find a nearest POI and navigating to the nearest POI. In an embodiment, the information of the POI decoded by the decoder 14 can be provided to an electronic device having an electronic map, so as to mark the location of the POI on the electronic map.

Within the DVB AV data, a vertical blanking interval (VBI) exists between every two frame data or field data. The information of the POI is added into a Packetized Elementary Stream (PES) packet of the VBI. For example, a PES packet data field of the PES packet is used for storing the information of the POI. The format of the PES packet is illustrated in FIG. 1B. A PES packet 19 comprises a stream identification (ID) 191, a PES packet length 192, a data alignment indicator 193, a PES header data length 194, stuffing bytes 195, and a PES packet data 196. The field of the PES packet data 196 is subdivided into fields of a data ID 1961, a plurality of data units 1962 and stuffing bytes 1963. In this embodiment, the data ID field 1961 is set as a predetermined value to indicate that the field of the PES packet data 196 is stored with the information of the POI. Each of the data unit 1962, comprising fields of a data unit ID 1964, a data unit length 1965 and a data 1966, stores with certain information of the POI. For instance, if the data unit ID 1964 is “01”, it means that the data unit 1962 is stored with the name of the POI; if the data unit ID 1964 is “02”, it means that the data unit 1962 is stored with the phone number of the POI; and so on. The stuffing bytes 1963 are used for complementing the length needed by the field of the PES packet data 196. In this preferred embodiment, the decoder 14 comprises an audio decoder 141, a VBI decoder 142 and a video decoder 143 as shown in FIG. 1C. The DVB signal outputted by the demodulator 13 comprises an audio stream, a VBI stream and a video stream. The audio decoder 141 decodes the audio stream and outputs the decoded result to a speaker 15. The video decoder 143 decodes the video stream and outputs the decoded result to a display panel 16. The VBI decoder 142 decodes the VBI stream to generate the information of the POI contained in the VBI stream. The VBI decoder 142 can output the information of the POI to a navigation device 17, such as a personal digital assistant (PDA) or a mobile phone with navigating function, so as to perform navigation or mark the position of the POI on the electronic map.

In this preferred embodiment, the DVB signal outputted by the demodulator 13 comprises a large number of images of the DVB AV data broadcasted by the provider and the related information of the POI included in each of the images. The decoder 14 of the DVB receiver 10b can receive a select signal inputted by the user via a user interface 18, so as to select a certain image or images of a certain segment of the DVB signal. For example, when the display panel 16 has a touch control function, the user can select a current display image by touching the display panel 16 directly. The decoder 14 decodes the DVB signal according to the select signal, so as to generate the information of the POI of the selected image and provide the information to the user. For instance, the information of the POI can be displayed on the display panel 16.

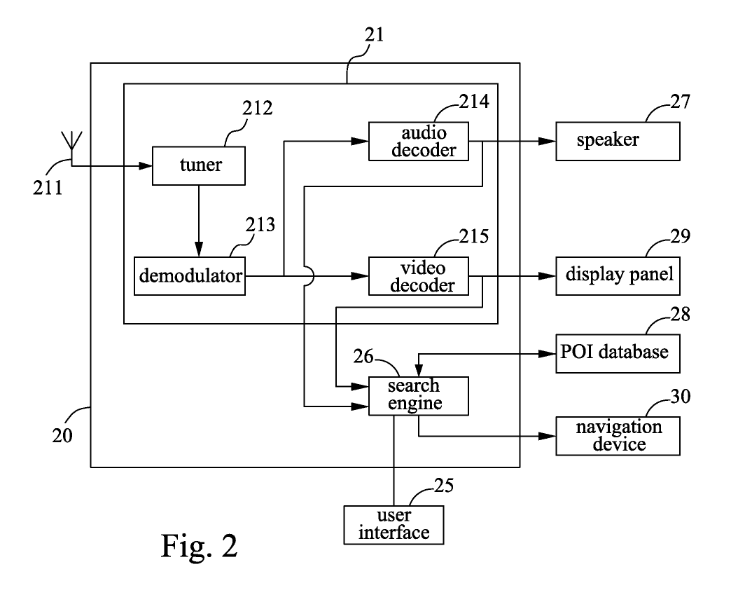

FIG. 2 is a block diagram of a DVB receiver in accordance with an embodiment of the present invention. The DVB receiver 20 comprises a signal processing module 21 and a search engine 26. The signal processing module 21 comprises an antenna 211, a tuner 212, a demodulator 213, an audio decoder 214 and a video decoder 215. The antenna 211 receives a DVB RF signal sent from a transmitting end of a system provider. The tuner 212 converts the DVB RF signal to an IF signal to be transmitted to the demodulator 213. The demodulator 213 converts the analog IF signal to a digital stream signal such as a DVB signal. The digital stream signal comprises an audio stream and a video stream, which are sent to the audio decoder 214 and the video decoder 215 respectively. The audio decoder 214 decodes the audio stream to generate an audio data, which is outputted to be played by a speaker 27 and is also sent to the search engine 26. The search engine 26 is coupled to a POI database 28 which is stored with a plurality of POIs and their associated information. The search engine performs audio recognition on the audio data, so as to recognize the POI included in the audio data, such as a name of the POI. On the other hand, the video decoder 215 decodes the video stream to generate a video data, which is outputted to be displayed by a display panel 29 and is also sent to the search engine 26. The search engine performs image recognition on the video data. For example, the search engine performs optical character recognition to recognize the POI included in the video data, such as a name or trademark of the POI. The search engine 26 then utilizes the POI recognized from the audio data or the video data to search the POI database 28. When a same or similar POI is found, information of the POI is accessed from the POI database 28. In FIG. 2, the POI database 28 is outside the DVB receiver 20 and is connected to the DVB receiver 20 via a wired or wireless manner. For example, when the DVB receiver 20 is integrated to a mobile phone and the POI database 28 is on a server of a mobile system provider, the DVB receiver 20 accesses the POI database 28 at a remote end via the mobile phone. In another embodiment, the POI database 28 can be integrated inside the DVB receiver 20.

In a preferred embodiment, the stream signal generated by the demodulator 213 comprises a text data having subtitles of a program or an advertisement with the format of the Closed Caption system, the Teletext system, or the Subtitle system. The search engine 26 recognizes a POI from the text data of the stream signal and searches the POI database according to the POI.

In a preferred embodiment, the search engine 26 outputs the information of the POI to a navigation device 30, and then the navigation device 30 can perform navigation according to the information of the POI. In another embodiment, the DVB AV data outputted by the video decoder 215 and the audio decoder 214 comprises a large number of images. The search engine 26 of the DVB receiver 20 receives a select signal inputted by the user via a user interface 25, so as to select information included in a certain image or images of a certain segment of the DVB AV data. Then, the search engine 26 recognizes a POI from the selected image or the images of the segment of the DVB AV data and searches the POI database 28 according to the POI.

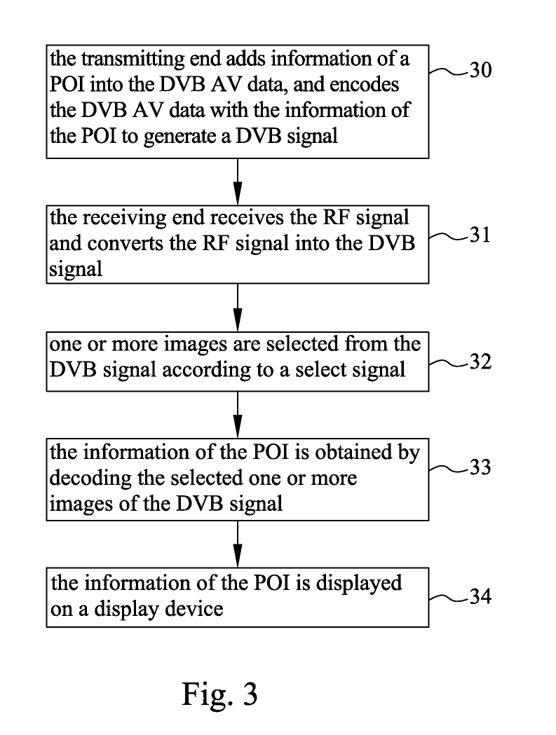

FIG. 3 is a flow chart of a method for providing information of POIs in accordance with an embodiment of the present invention. In this embodiment, the method is applied to a DVB system. In step 30, the transmitting end of the DVB system adds information of a POI, which is related to a DVB AV data or included in the DVB AV data, into the DVB AV data, and encodes the DVB AV data with the information of the POI to generate a DVB signal to be converted into an RF signal to be transmitted. In a preferred embodiment, the information of the POI is included in the VBI of the DVB signal. For example, the information of the POI is included in a PES packet of the VBI.

In step 31, the receiving end of the DVB system receives the RF signal and converts the RF signal into a baseband digital stream signal such as the DVB signal.

In step 32, one or more images are selected from the DVB signal according to a select signal inputted by a user via a user interface.

In step 33, the information of the POI is obtained by decoding the selected one or more images of the DVB signal.

In step 34, the information of the POI is displayed on a display device, so as to provide the information to the user.

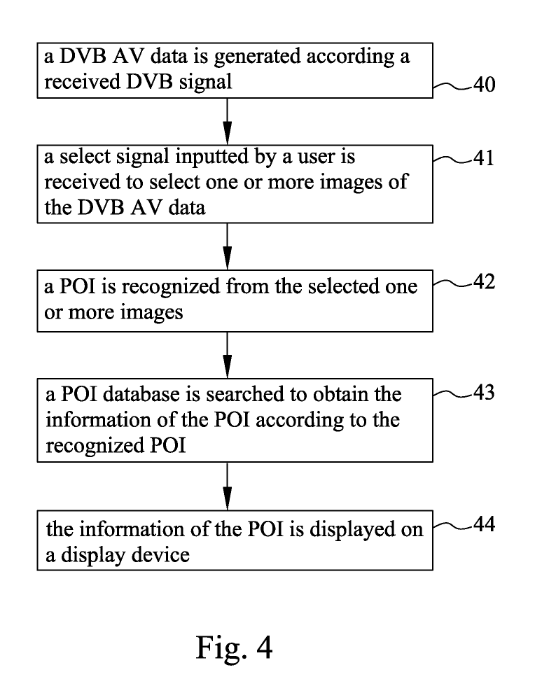

FIG. 4 is a flow chart of a method for providing information of POIs in accordance with another embodiment of the present invention. In this embodiment, the method is applied to a DVB receiver. In step 40, a DVB AV data is generated by decoding a received DVB signal. The DVB AV data comprises a video data, an audio data and a text data.

In step 41, a select signal inputted by a user is received to select one or more images of the DVB AV data.

In step 42, a POI is recognized from the selected one or more images. That is, image recognition such as optical character recognition and voice recognition is performed respectively on a video data and an audio data of selected one or more images of the DVB AV data, so as to recognize the POI.

In step 43, a POI database is searched to obtain the information of the POI according to the POI as recognized in step 42.

In step 44, the information of the POI is displayed on a display device, so as to provide the information to the user.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A digital television system, comprising:
a transmitting end, for adding information of a point of interest (POI) into a digital audio/video (AV) data, encoding the digital AV data as a digital AV signal, and transmitting the digital AV signal; and
a receiving end, comprising:
a digital AV receiver, for receiving the digital AV signal and obtaining the information of the POI by decoding the digital AV signal; and
a display device, coupled to the digital AV receiver, for displaying the information of the POI.

2. The digital television system as claimed in claim 1, wherein the information of the POI is in a vertical blanking interval of the digital AV signal.

3. The digital television system as claimed in claim 1, wherein the information of the POI is relating to the digital AV data.

4. The digital television system as claimed in claim 1, wherein the receiving end further comprises:
a user interface, for receiving a select signal inputted by a user to select one or more images of the digital AV signal;
wherein the digital AV receiver decodes the digital AV signal according to the select signal to obtain the information of the POI corresponding to the one or more images.

5. The digital television system as claimed in claim 1, wherein the receiving end further comprises:
a navigation device, for performing navigation according to the information of the POI obtained by the digital AV receiver.

6. A digital television receiver, comprising:
a decoder, for decoding a digital AV signal to generate a digital AV data; and
a search engine, coupled to the decoder, for recognizing a point of interest (POI) from the digital AV data, searching the POI in a POI database, and outputting information of the POI.

7. The digital television receiver as claimed in claim 6, further comprising:
a display device, for displaying the information of the POI.

8. The digital television receiver as claimed in claim 6, wherein the digital AV data comprises a video data, and the search engine performs image recognition on the video data for identifying the POI.

9. The digital television receiver as claimed in claim 6, wherein the digital AV data comprises an audio data, and the search engine performs voice recognition on the audio data for identifying the POI.

10. The digital television receiver as claimed in claim 6, wherein the digital AV data comprises a text data, and the search engine obtains the POI from the text data.

11. The digital television receiver as claimed in claim 6, further comprises:
a user interface, for receiving a select signal inputted by a user;
wherein the search engine selects one or more images of the digital AV data according to the select signal and identifies the POI from the one or more images.

12. The digital television receiver as claimed in claim 6, wherein the digital television receiver is coupled to a navigation device, which performs navigation according to the information of the POI outputted by the search engine.

13. A method for providing information of a point of interest (POI) to a receiving end of a digital television system, said digital television system has a transmitting end which adds information of the POI into a digital AV data and encodes the digital AV data to generate a digital AV signal, the method comprising:
receiving the digital AV signal;
decoding the digital AV signal to obtain the information of the POI, and
displaying the information of the POI.

14. The method as claimed in claim 13, wherein the information of the POI is in a vertical blanking interval of the digital AV signal.

15. The method as claimed in claim 14, wherein the information of the POI is in a PES packet of the vertical blanking interval.

16. The method as claimed in claim 13, wherein the information of the POI is relating to the digital AV data.

17. The method as claimed in claim 13, further comprising:
receiving a select signal inputted by a user; and
selecting one or more images of the digital AV signal according to the select signal;
wherein the digital AV signal is decoded to obtain the information of the POI according to the selected one or more images.

18. A method for providing information of a point of interest (POI) to a digital television receiver, comprising:
receiving a digital AV signal;
decoding the digital AV signal to generate a digital AV data;
recognizing the POI from the digital AV data; and
searching a POI database to obtain information of the POI according to the POI.

19. The method as claimed in claim 18, further comprising:
displaying the information of the POI.

20. The method as claimed in claim 18, wherein the digital AV data comprises a video data, and the step of recognizing the POI from the digital AV data comprises:
performing image recognition on the video data for identifying the POI.

21. The method as claimed in claim 18, wherein the digital AV data comprises an audio data, and the step of recognizing the POI from the digital AV data comprises:
performing voice recognition on the audio data for identifying the POI.

22. The method as claimed in claim 18, wherein the digital AV data comprises a text data, and step for recognizing the POI from the digital AV data further comprises recognizing the POI from the text data.

23. The method as claimed in claim 18, wherein recognizing step for recognizing the POI from the digital AV data further comprises:
receiving a select signal inputted by a user to select one or more images of the digital AV data; and
recognizing the POI from the selected one or more images.
